(19) United States
(12) Patent Application Publication
(10) Pub. No.: US 2025/0015417 A1
(43) Pub. Date: Jan. 9, 2025

(54) BATTERY FOR HAIR CLIPPERS

(71) Applicant: CONAIR LLC, Stamford, CT (US)

(72) Inventors: Vito James CARLUCCI, Stratford, CT (US); Dennis J. COLPITTS, Fairfield, CT (US); Bradley SLOSS, Stamford, CT (US)

(73) Assignee: CONAIR LLC, Stamford, CT (US)

(21) Appl. No.: 18/349,072

(22) Filed: Jul. 7, 2023

(51) Int. Cl. H01M 50/247; H01M 10/48; H01M 50/107

(52) U.S. Cl. CPC H01M 50/247; H01M 10/488; H01M 50/107; B26B 19/3873; H01M 2220/30

(57) ABSTRACT

A rechargeable battery for a hair clipper includes a body having a plurality of indentations with each of the plurality of indentations being shaped to receive a fastener member of a different hair clipper. A rechargeable battery assembly for a hair clipper also includes a rechargeable battery having a body. The body having groove and a first projection in the groove with a cavity of the hair clipper that has a resilient member that extends into the cavity, and the resilient member being insertable into the groove.

### BACKGROUND

### 1. Field of the Disclosure

The present disclosure relates to a battery for hair clippers. In particular, the present disclosure relates to a rechargeable battery that can be used in multiple hair clippers that have different designs. The present disclosure also relates to a retaining assembly that maintains the rechargeable battery connected to the hair clipper when the rechargeable battery is released from the hair clipper to avoid undesirably dropping the rechargeable battery.

### 2. Description of Related Art

A conventional hair clipper can have a rechargeable battery. Hair clippers having different designs require rechargeable batteries that also have different designs. The need for rechargeable batteries that have different designs undesirably increases the cost of manufacturing different hair clippers. In addition, the need for rechargeable batteries that have different designs requires owners of different hair clippers to purchase more than one rechargeable battery additionally increasing costs to owners.

Rechargeable batteries can also be detachable from conventional hair clippers. Rechargeable batteries often are dropped when removing the rechargeable batteries from conventional hair clippers resulting in a negative impact.

Accordingly, it has been determined by the present disclosure that there is a continuing need for a device that overcomes, alleviates, and/or mitigates one or more of the aforementioned and other deleterious effects of prior devices.

### SUMMARY

The present disclosure provides a rechargeable battery that can be used in multiple hair clippers that have different designs.

The present disclosure also provides a retaining assembly that maintains the rechargeable battery connected to the hair clipper when the rechargeable battery is released from the hair clipper to avoid undesirably dropping the rechargeable battery.

A rechargeable battery for a hair clipper is provided that includes a body having a plurality of indentations with each of the plurality of indentations being shaped to receive a fastener member of a different hair clipper.

A rechargeable battery assembly for a hair clipper is also provided that includes a rechargeable battery having a body. The body has a groove and a first projection in the groove. A cavity of the hair clipper is also included that has a resilient member that extends into the cavity. The resilient member is insertable into the groove.

The above-described and other features and advantages of the present disclosure will be appreciated and understood by those skilled in the art from the following detailed description, drawings, and appended claims.

### DESCRIPTION OF THE DRAWINGS

FIG. 1 is a bottom rear perspective view of a battery according to the present disclosure.

FIG. 2 is a bottom front perspective view of the battery of FIG. 1.

FIG. 3 is a rear view of the battery of FIG. 1.

FIG. 4 is a front view of the battery of FIG. 1.

FIG. 5 is a side view of the battery of FIG. 1.

FIG. 6 is a side view of the battery of FIG. 1 rotated 180 degrees from FIG. 5.

FIG. 7 is a bottom view of the battery of FIG. 1.

FIG. 8 is a top view of the battery of FIG. 1.

FIG. 9 is a bottom, front perspective view of the battery of FIG. 1 inserted in a first hair clipper in an operational position.

FIG. 10 is a rear view of the first hair clipper of FIG. 9.

FIG. 11 is a side cross-sectional view of the first hair clipper of FIG. 9 having the battery of FIG. 1 removed.

FIG. 12 is a side cross-sectional view of the first hair clipper of FIG. 9 having the battery of FIG. 1 inserted in the first hair clipper of FIG. 9 in an operational position.

FIG. 13 is a side view of a housing of the first hair clipper of FIG. 9.

FIG. 14 is a bottom perspective view of an inner sleeve of the first hair clipper of FIG. 9.

FIG. 15 is a top perspective view of the inner sleeve of FIG. 14.

FIG. 16 is a bottom view of the inner sleeve of FIG. 14.

FIG. 17 is a bottom cross-sectional perspective view of a rear portion of the inner sleeve of FIG. 14.

FIG. 18 is a top cross-sectional perspective view of a front portion of the inner sleeve of FIG. 14.

FIG. 19 is a bottom front perspective view of the battery of FIG. 1 inserted in a second hair clipper in an operational position.

FIG. 20 is a side view of the second hair clipper of FIG. 19 with an outer sleeve removed.

FIG. 21 is a side cross-sectional view of the second hair clipper of FIG. 20.

FIG. 22 is a partial side cross-sectional view of the second hair clipper of FIG. 20.

FIG. 23 is a top perspective view of an inner sleeve of the second hair clipper of FIG. 19.

FIG. 24 is a rear view of the inner sleeve of FIG. 23.

FIG. 25 is a bottom perspective view of the inner sleeve of FIG. 23.

FIG. 26 is a bottom perspective view of a lower housing of the second hair clipper of FIG. 19.

FIG. 27 is a partial side view of the lower housing of FIG. 26.

FIG. 28 is a partial side view of the lower housing of FIG. 26.

FIG. 29 is a partial bottom perspective view of the lower housing of FIG. 26.

FIG. 30 is a partial bottom view of the lower housing of FIG. 26.

FIG. 31 is a rear view of the battery of FIG. 1 inserted in a third hair clipper in an operational position.

FIG. 32 is a front view of the third hair clipper of FIG. 31.

FIG. 33 is a bottom view of the third hair clipper of FIG. 31.

FIG. 34 is a side view of the third hair clipper of FIG. 31.

FIG. 35 is a side perspective exploded view of the third hair clipper of FIG. 31.

FIG. 36 is a side perspective view of a battery charger.

FIG. 37 is a top view of the battery charger of FIG. 36.

FIG. 38 is a rear view of the battery charger of FIG. 36.

### DETAILED DESCRIPTION

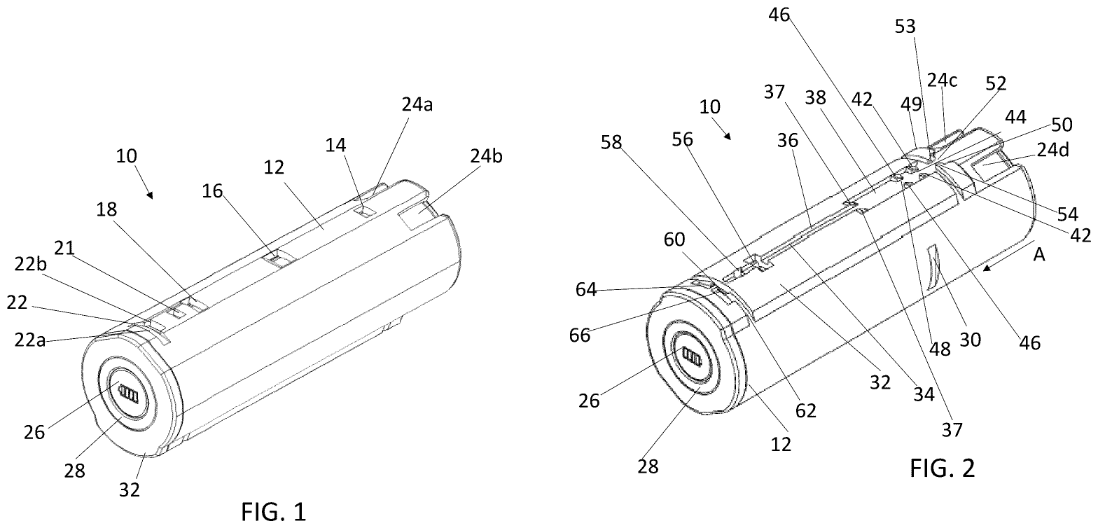

Referring to the drawings and in particular to FIG. 1, an exemplary embodiment of a battery according to the present disclosure is shown and is generally referred to by reference numeral 10. Advantageously, battery 10 is a rechargeable battery that can be used in multiple hair clippers that have different designs. Another advantage is that battery 10 can be maintained in the hair clipper when battery 10 is released from the hair clipper to avoid undesirably dropping battery. Alternatively, battery 10 can be used with a hair trimmer.

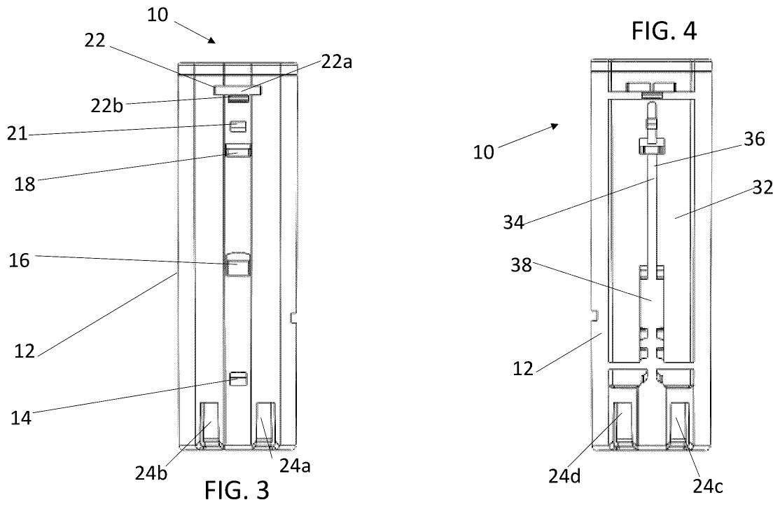

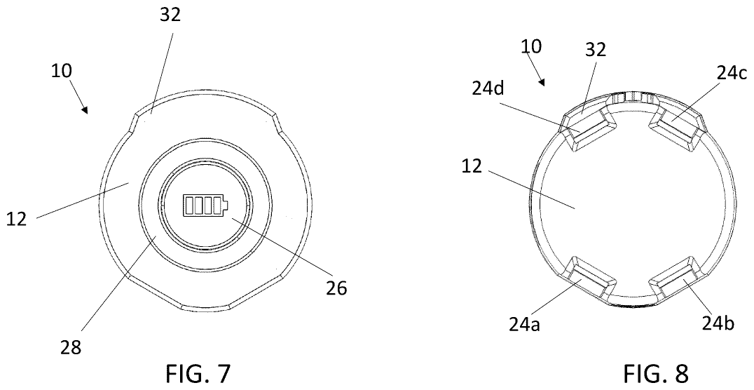

Battery 10 is a rechargeable battery, for example, is a lithium ion battery that is rechargeable. Still referring to FIGS. 1 and 3, battery 10 has a body 12. A first indentation 14, a second indentation 16, a third indentation 18, a fourth indentation 21, and a fifth indentation 22 are formed in body 12. Fifth indentation 22 has a portion 22a with a first depth and width and a portion 22b with a second depth and width. The first width of portion 22a is greater than the second width of portion 22b. The second depth of portion 22b is greater than the first depth 22a. Battery 10 has contacts 24a, 24b, 24c, 24d, as shown in FIG. 8, connected to body 12. Body 12 can be substantially a cylindrical shape and can have flattened surfaces along the cylindrical shape, for example, flattened surfaces that each extend from one of contacts 24a and 24b. Body 12 has a button 26 that is surrounded by lights 28, as shown in FIG. 7, for example, light emitting diodes “LEDs”. One or more lights 28 can be illuminated when button 26 is depressed to indicate an amount battery 10 that is charged. For example, if 50 percent of battery 10 is charged, then half the circle of lights 28 will be illuminated.

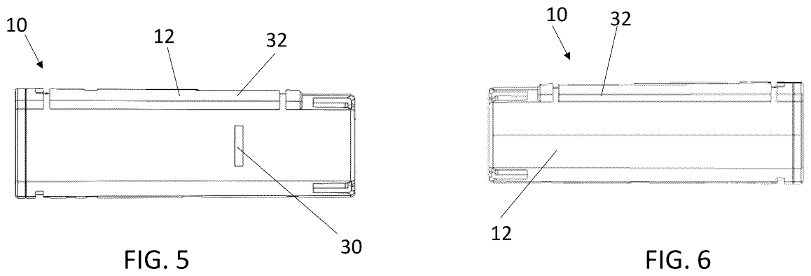

Referring to FIGS. 2 and 4, a sixth indentation 30 is formed in body 12. A raised portion 32 is formed on body 12. Raised portion 32 extends outward from body 12, as shown in FIGS. 5 and 6. As shown in FIGS. 2 and 4, first groove 34 is formed in raised portion 32. First groove 34 has a first portion 36 having a first width and a second portion 38 having a second width that is greater than the first width. Ramps 37 are formed at a transition from second portion 38 to first portion 36. Ramps 37 increase in height in a direction toward button 26. First projections 42 are formed in second portion 38 adjacent an end of second portion 38 opposite first portion 36. First projections 42 increase in height in a direction A to about the same height as raised portion 32 to form ramps. A space 44 is formed between first projections 42. Second projections 46 are formed in second portion 38 adjacent first projections 42. Second projections 46 increase in height in direction A to about the same height as raised portion 32 to form ramps. A space 48 is formed between second projections 46. Battery 10 has raised structures 49, 50 formed on body 12. Raised structures 49, 50 have a space 52 that is aligned with first groove 34. Raised structures 49, 50 each have ends that face one another that form ramps 53, 54, respectively, that increase in height in a direction A to about the same height as raised portion 32. Battery 10 has seventh indentation 56, eighth indentation 58 and ninth indentation 60 in raised portion 32. A perimeter groove 62 extends through raised portion 32. Depressions 64, 66 extend from perimeter groove 62 into raised portion 32.

Advantageously, different hair clippers can insert a fastening member into first indentation 14, second indentation 16, third indentation 18, fourth indentation 21, fifth indentation 22, sixth indentation 30, seventh indentation 56, eighth indentation 58 and/or ninth indentation 60, to allow for connection between different hair clippers and battery 10 so that battery 10 can be used with different hair clippers.

Another advantage is that battery 10 can form a retaining assembly with a hair clipper to maintain battery 10 connected to different hair clippers when battery 10 is released from the different hair clippers to avoid undesirably dropping battery 10.

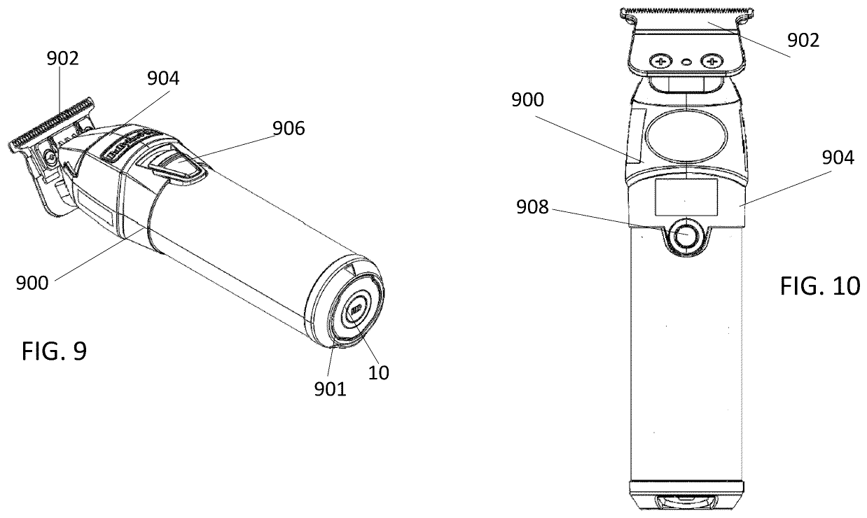

Referring to FIG. 9, battery 10 is insertable into a first hair clipper 900. Battery 10 is inserted through an opening 901 in first hair clipper 900 to an operational position secured in first hair clipper 900. Opening 901 has the same shape as the perimeter of battery 10 so that battery 10 is inserted with a predetermined orientation.

Referring to FIGS. 9 and 10, hair clipper 900 has a blade 902 and body 904. Body 904 has an activation button 906, as shown in FIG. 9, and release button 908, as shown in FIG. 10. A user can press activation button 906 to activate hair clipper 900 for cutting hair as is known in the art. A user can press release button 908 to remove battery 10 from hair clipper 900.

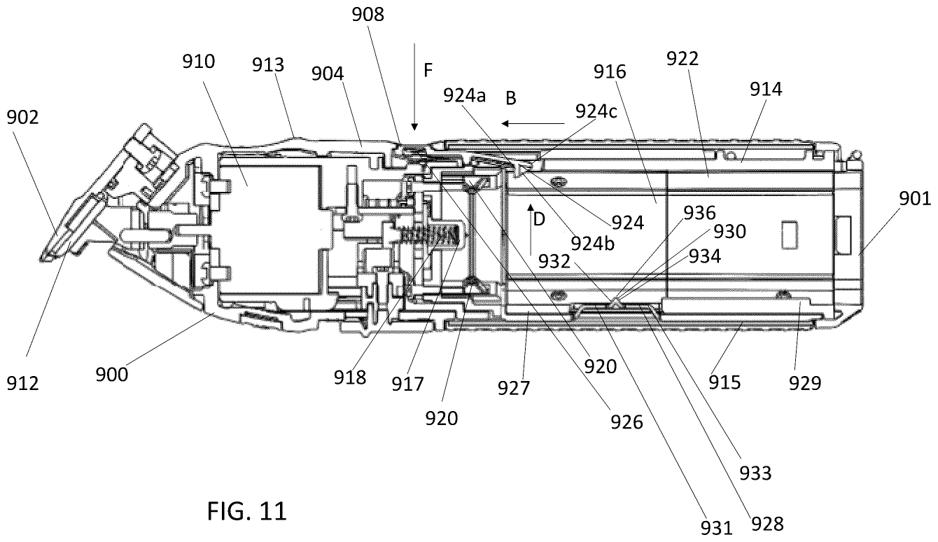

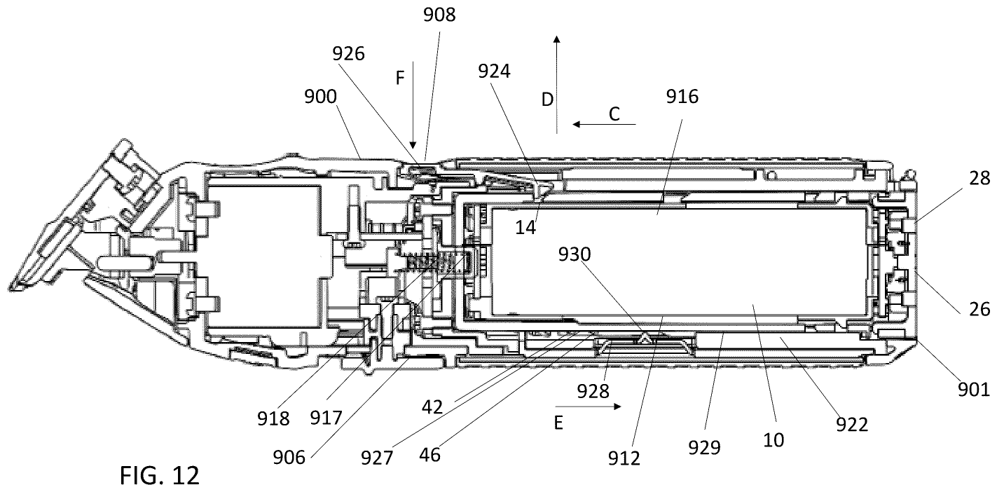

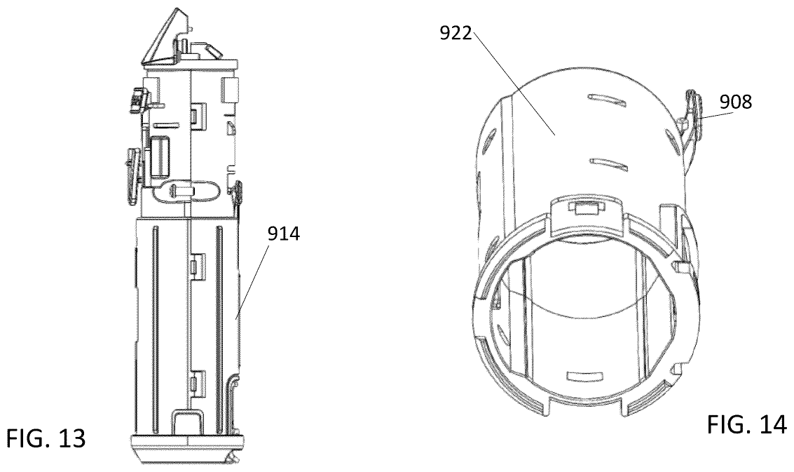

Referring to FIG. 11, hair clipper 900 has a motor 910 that receives power from battery 10 when in the operational position to move a moving blade 912 as is known in the art allowing a user to cut hair with hair clipper 900. Body 904 has an upper housing 913 that houses motor 910 and a lower housing 914 that surrounds a cavity 916. Referring to FIGS. 11 and 13, lower housing 914 is in an outer sleeve 915. Lower housing 914 is connected to a retractable member 917 that extends into cavity 916. Retractable member 917 is biased to a release position, as shown in FIG. 11, by a first biasing member 918. Retractable member 917 is retractable so that a portion of retractable member 917 is movable outside of cavity 916, as shown in FIG. 12, when a force in a direction B is applied to retractable member 917 that overcomes a force applied to retractable member 917 by first biasing member 918. When the force in direction B is removed from retractable member 917, then retractable member 917 is urged by first biasing member 918 back to the release position. First biasing member 918 is shown as a spring, however, different biasing members could be used. As shown in FIG. 11, contacts 920 extend into cavity 916 through lower housing 914. Contacts 920 can be spring members that are resilient and biased to a contact position, as shown in FIG. 11.

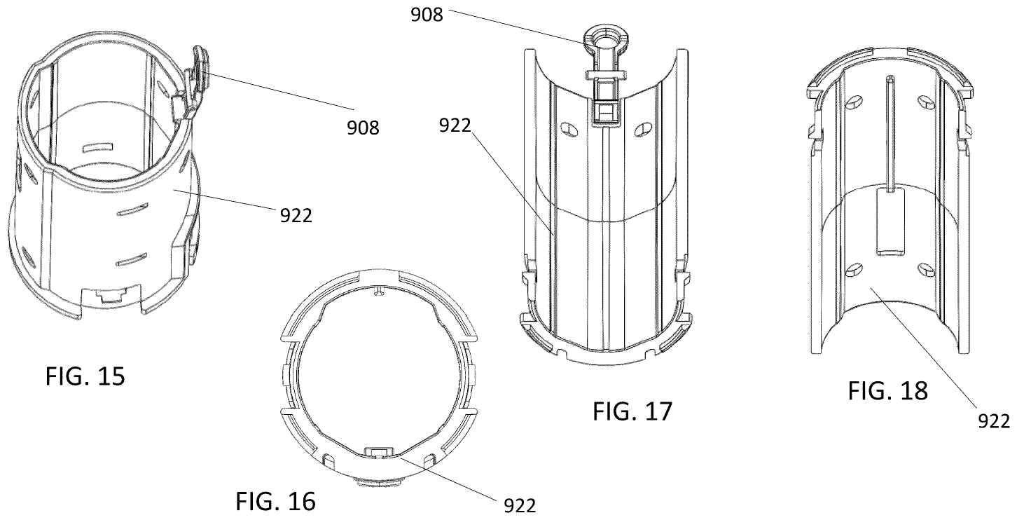

Still referring to FIGS. 11 and 14-18, an inner sleeve 922 is positioned in lower housing 914. Inner sleeve 922 forms opening 901 through a bottom of hair clipper 900. Release button 908 is connected to a fastener member 924 that extends into cavity 916 through lower housing 914 and inner sleeve 922. Release button 908 is biased to an outward position, as shown in FIG. 11, by a release biasing member 926. Release biasing member 926 is shown as a spring, however, different biasing members could be used. When release button 908 is biased to an outward position, fastener member 924 is urged inward toward a center of cavity 916. When a force F is applied to release button 908 overcoming a force applied to release button 908 by release biasing member 926, release button 908 is moved inward toward a center of cavity 916 that also moves fastener member 924 in a direction D outward away from the center of cavity 916. When force F is no longer applied to release button 908, release biasing member 926 urges release button 908 outward away from the center of cavity 916 to the outward position to move fastener member 924 in a direction opposite direction D toward the center of cavity 916. Fastener member 924 is shaped to have flat side 924a, an incline ramp 924b, and a protuberance 924c formed between flat side 924a and incline ramp 924b.

Still referring to FIG. 11, a resilient member 928 extends into cavity 916 through inner sleeve 922. Resilient member 928 can be connected to lower housing 914. Resilient member 928 forms a protrusion 930 and legs 931, 933 that extend from opposite sides of protrusion 930. Alternatively, resilient member 928 has only one of legs 931, 933 and protrusion 930. Legs 931, 933 can each have an opening therethrough. Protrusion 930 is shaped to have a first ramp 932 and a second ramp 934 that taper from an apex 936 in opposite directions. Protrusion 930 is biased to an initial position, as shown in FIG. 11. Protrusion 930 is movable from the initial position away from the center of cavity 916 when a force that overcomes the bias of resilient member 928 is applied, and protrusion 930 returns to the initial position, as shown in FIG. 11, when the force is no longer applied to protrusion 930. Inner sleeve 922 has ribs 927, 929 on opposite sides of resilient member 928 that are sized to fit in first groove 34. Alternatively, ribs 927, 929 can be omitted.

Referring to FIG. 9, battery 10 is insertable through opening 901 in first hair clipper 900. Opening 901 in first hair clipper 900 has the same shape as the perimeter of battery 10 so that battery 10 must be inserted with the predetermined orientation aligning first groove 34 in raised portion 32 of battery 10 with resilient member 928 in cavity 916 of first hair clipper 900, as shown in FIG. 12.

Referring to FIG. 12, as battery 10 is inserted through opening 901 in first hair clipper 900, body 12 of battery 10 slides in a direction C on inner sleeve 922 of first hair clipper 900 so that protrusion 930 and rib 929 of first hair clipper 900 move in first groove 34 of battery 10 until protrusion 930 abuts first projections 42 extending from body 12 of battery 10. When a force that overcomes the bias of resilient member 928 is applied by first projections 42 as battery 10 slides in a direction C on inner sleeve 922, protrusion 930 moves from the initial position away from the center of cavity 916 sliding over first projections 42 and protrusion 930 returns to the initial position, as shown in FIG. 11, when the force is no longer applied to protrusion 930 by first projections 42. Battery 10 then continues to slide in direction C on inner sleeve 922 of first hair clipper 900 so that protrusion 930 of first hair clipper 900 moves in first groove 34 of battery 10 up to second projections 46 extending from body 12 of battery 10. When a force that overcomes the bias of resilient member 928 is applied by second projections 46 as battery 10 slides in a direction C on inner sleeve 922, protrusion 930 moves from the initial position away from the center of cavity 916 sliding over second projections 46 and protrusion 930 returns to the initial position, as shown in FIG. 11, when the force is no longer applied to protrusion 930 by second projections 46. Battery 10 then continues to slide in a direction C on inner sleeve 922 of first hair clipper 900 up to fastener member 924 while protrusion 930 of first hair clipper 900 moves in first groove 34 of battery 10. When a force is applied by battery 10 to fastener member 924 overcoming the force applied to release button 908 and fastener member 924 by release biasing member 926, release button 908 is moved inward toward the center of cavity 916 that also moves fastener member 924 in direction D outward away from the center of cavity 916 allowing battery 10 then to continue to slide in a direction C. Battery 10 then continues to slide in a direction C on inner sleeve 922 of first hair clipper 900 until battery 10 abuts retractable member 917. When the force is applied in direction B by battery 10 to retractable member 917 that overcomes the force applied to retractable member 917 by first biasing member 918, then retractable member 917 retracts with the movement of battery 10 continuing to slide in a direction C on inner sleeve 922 of first hair clipper 900 until fastener member 924 is positioned over first indentation 14 in battery 10. When fastener member 924 is positioned over first indentation 14 in battery 10 release biasing member 926 urges fastener member 924 into first indentation 14 in battery 10 maintaining battery 10 in the operational position. In the operational position, contacts 20 of battery 10 are each aligned with one of contacts 920 so that current is conducted from battery 10 to contacts 920 to power motor 910 as known in the art of first hair clipper 900. Retractable member 917 is retracted from the release position in the operational position. In the operational position, button 26 is flush with a bottom end of first hair clipper 900 or button 26 is inside or outside of cavity 916 adjacent the bottom end of first hair clipper 900. While battery 10 is in the operational position and when the battery 10 is charged, then the user can move activation button 906 between the activation and deactivation position to activate and deactivate, respectively, first hair clipper 900.

To remove battery 10 from first hair clipper 900, a user applies force F to release button 908 overcoming the force applied to release button 908 by release biasing member 926. Release button 908 is moved inward toward the center of cavity 916 that also moves fastener member 924 in direction D outward away from the center of cavity 916 removing fastener member 924 from first indentation 14 thus allowing first biasing member 918 to urge retractable member 917 to move toward the release position pushing a portion of battery 10 out of opening 901 of first hair clipper 900 until protrusion 930 abuts second projections 46 to maintain battery 10 in a partially removed position that prevents battery 10 from dropping out of first hair clipper 900. The user can then grasp battery 10 and pull battery 10 in a direction E so that a force that overcomes the bias of resilient member 928 is applied by second projections 46 as battery 10 slides in direction E on inner sleeve 922 and protrusion 930 moves from the initial position away from the center of cavity 916 sliding over second projections 46 and protrusion 930 returns to the initial position, as shown in FIG. 11, when the force is no longer applied to protrusion 930 by second projections 46. The user can continue to grasp battery 10 and pull battery 10 in direction E so that a force that overcomes the bias of resilient member 928 is applied by first projections 42 as battery 10 slides in direction E on inner sleeve 922 and protrusion 930 moves from the initial position away from the center of cavity 916 sliding over first projections 42 and protrusion 930 returns to the initial position, as shown in FIG. 11, when the force is no longer applied to protrusion 930 by first projections 42. The user can then continue to grasp battery 10 and pull battery 10 in direction E to remove battery from first hair clipper 900.

Advantageously, when release button 908 is pressed by the user to remove battery 10 from first hair clipper 900, battery 10 does not undesirably fall out of first hair clipper 900 and instead only a portion of battery 10 is moved out of cavity 916 allowing the user to remove battery in a more controlled manner by pulling battery 10 the rest of the way out of first hair clipper 900 to avoid undesirably dropping battery 10.

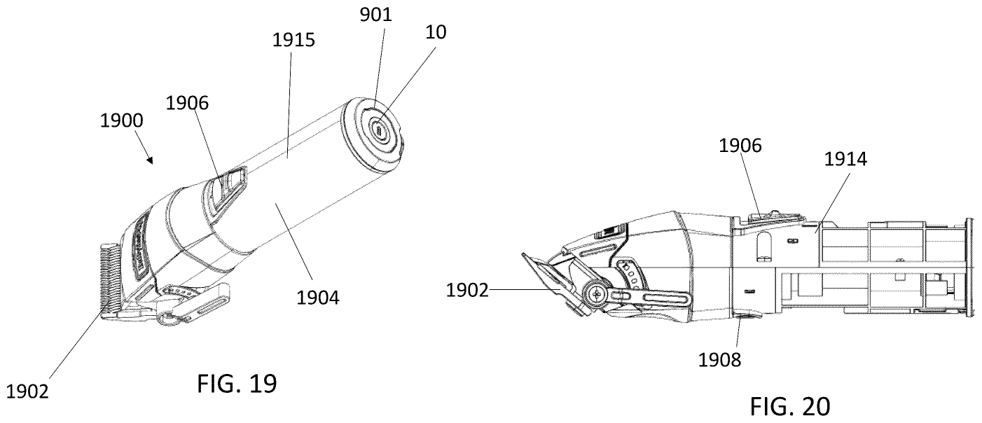

Referring to FIG. 19, battery 10 can be used with a second hair clipper 1900. Battery 10 connects to second hair clipper 1900 the same as battery 10 connects to first hair clipper 900. Features from first hair clipper 900 that are like features of second hair clipper 1900 use the same reference numerals.

Battery 10 is inserted through opening 901 in second hair clipper 1900 to the operational position and secured in second hair clipper 1900 the same as first hair clipper 900. Referring to FIGS. 19 and 20, second hair clipper 1900 has a blade 1902 and body 1904. Body 1904 has an activation button 1906 and release button 1908, as shown in FIG. 20. A user can press activation button 1906 to activate second hair clipper 1900 for cutting hair as is known in the art. A user can press release button 1908 to remove battery 10 from second hair clipper 1900 the same as the user presses release button 908 to remove battery 10 from first hair clipper 900.

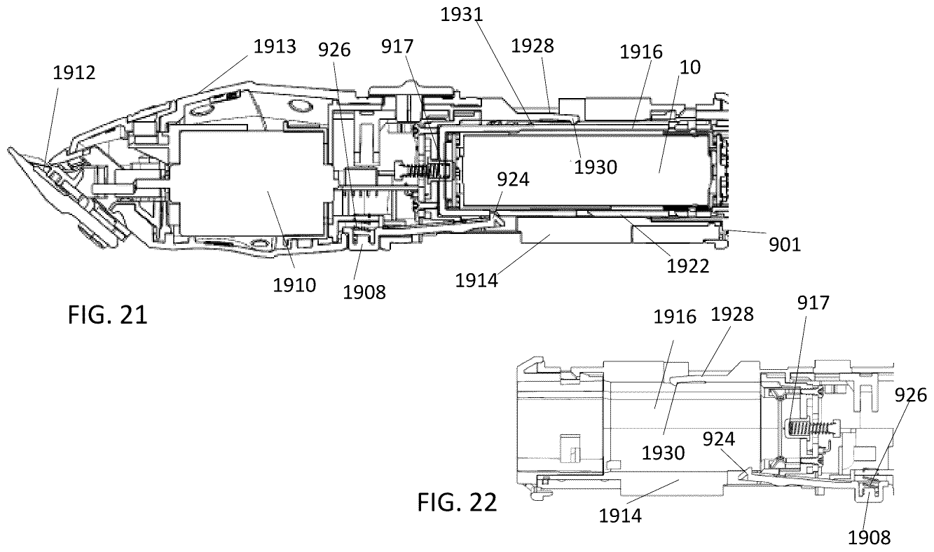

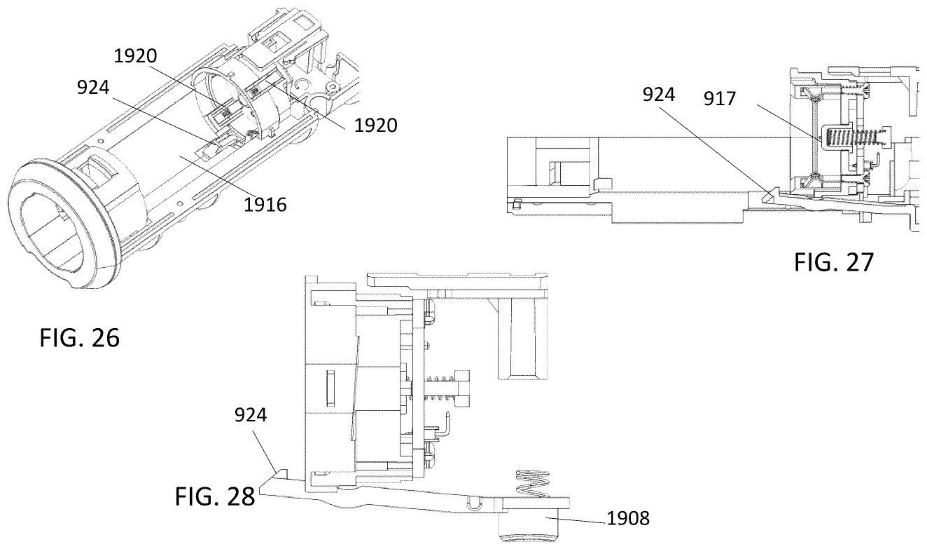

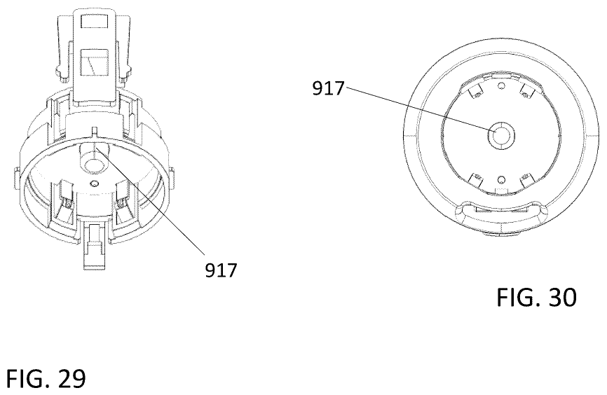

Referring to FIG. 21, second hair clipper 1900 has a motor 1910 that receives power from battery 10 when in the operational position to move a moving blade 1912 as is known in the art allowing a user to cut hair with second hair clipper 1900. Body 1904 has an upper housing 1913 that houses motor 1910 and lower housing 1914 that surrounds a cavity 1916. Lower housing 1914 is in an outer sleeve 1915, as shown in FIG. 19. Lower housing 1914 is connected to retractable member 917, as shown in FIGS. 26-30, that extends into cavity 1916. As shown in FIG. 26, contacts 1920 that are modified in shape from contacts 920 of first hair clipper 900 extend into cavity 1916 through lower housing 1914. Contacts 1920 can be spring members that are resilient and biased to a contact position, as shown in FIG. 26, so that each of contacts 1920 contact one of contacts 20 of battery 10 in the operational position to conduct electricity from battery 10 to contacts 1920 that conduct electricity to motor 1910.

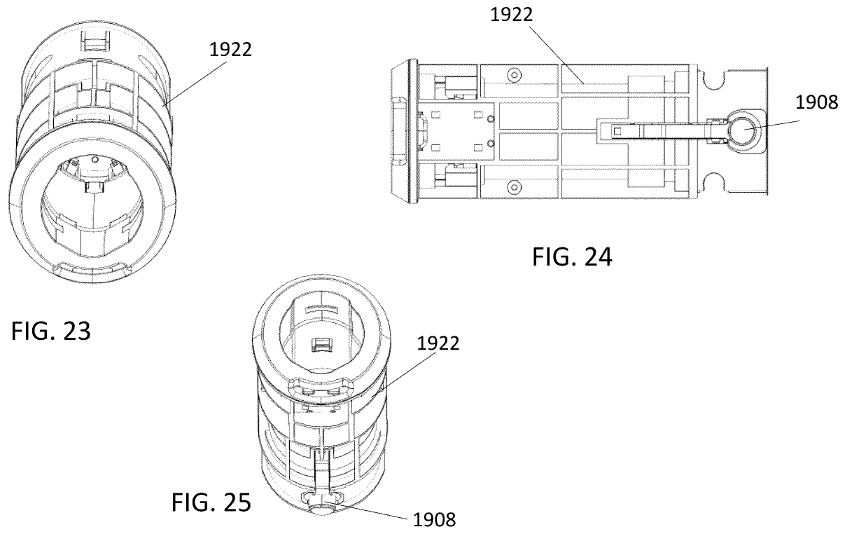

Referring to FIG. 21, inner sleeve 1922 is positioned in lower housing 1914. Inner sleeve 1922, as shown in FIGS. 22-25, forms opening 901 through a bottom of second hair clipper 1900. Release button 1908 that is modified from release button 908 to have a larger shape is connected to fastener member 924 that extends into cavity 1916 through lower housing 1914 and inner sleeve 1922. Release button 1908 is biased to the outward position by release biasing member 926. Release button 1908, release biasing member 926 and fastener member 924 of second hair clipper 1900 function the same as release button 908, release biasing member 926 and fastener member 924 of first hair clipper 900. In particular, fastener member 924 that is connected to release button 1908 is removably insertable in first indentation 14 of battery 10.

Still referring to FIG. 21, a resilient member 1928 that is modified in shape from resilient member 928 extends into cavity 1916. Resilient member 1928 can be connected to lower housing 1914. Resilient member 1928 forms a protrusion 1930 and leg 1931. Protrusion 1930 is shaped the same as protrusion 930 and resilient member 1928 functions the same as resilient member 928. Battery 10 is insertable into second hair clipper 1900 and removable from second hair clipper 1900 the same as first hair clipper 900 described herein.

Advantageously, when release button 1908 is pressed by the user to remove battery 10 from second hair clipper 1900, battery 10 does not undesirably fall out of second hair clipper 1900 and instead only a portion of battery 10 is moved out of cavity 1916 allowing the user to remove battery in a more controlled manner by pulling battery 10 the rest of the way out of second hair clipper 1900 to avoid undesirably dropping battery 10 as described herein for first hair clipper 900.

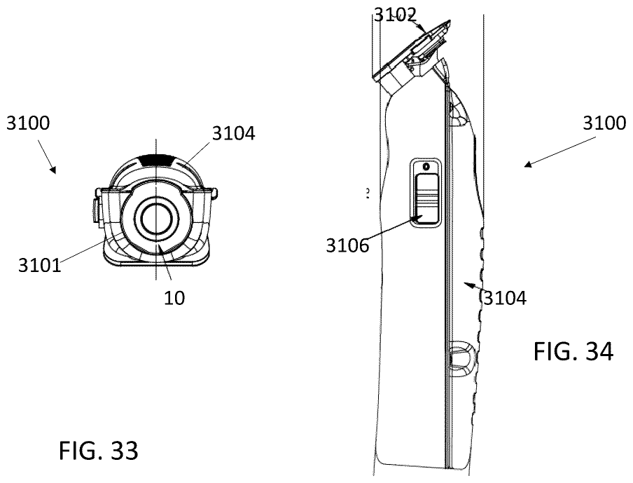

Referring to FIG. 31, battery 10 can be used with a third hair clipper 3100. Battery 10 is inserted through an opening 3101, as shown in FIG. 33, to an operational position secured in third hair clipper 3100. Opening 3101 has the same shape as the perimeter of battery 10 so that battery 10 is inserted with a predetermined orientation.

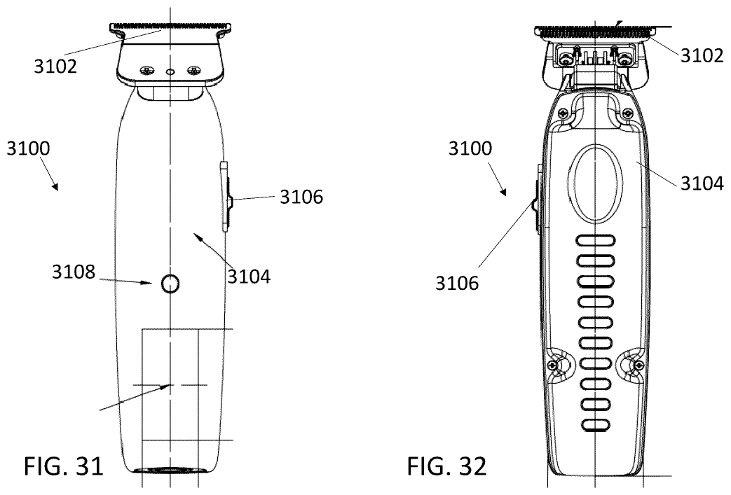

Referring to FIGS. 31-34, third hair clipper 3100 has a blade 3102 and body 3104. Body 3104 has an activation button 3106 and release button 3108. A user can press activation button 3106 to activate third hair clipper 3100 for cutting hair as is known in the art. A user can press release button 3108 to remove battery 10 from third hair clipper 3100.

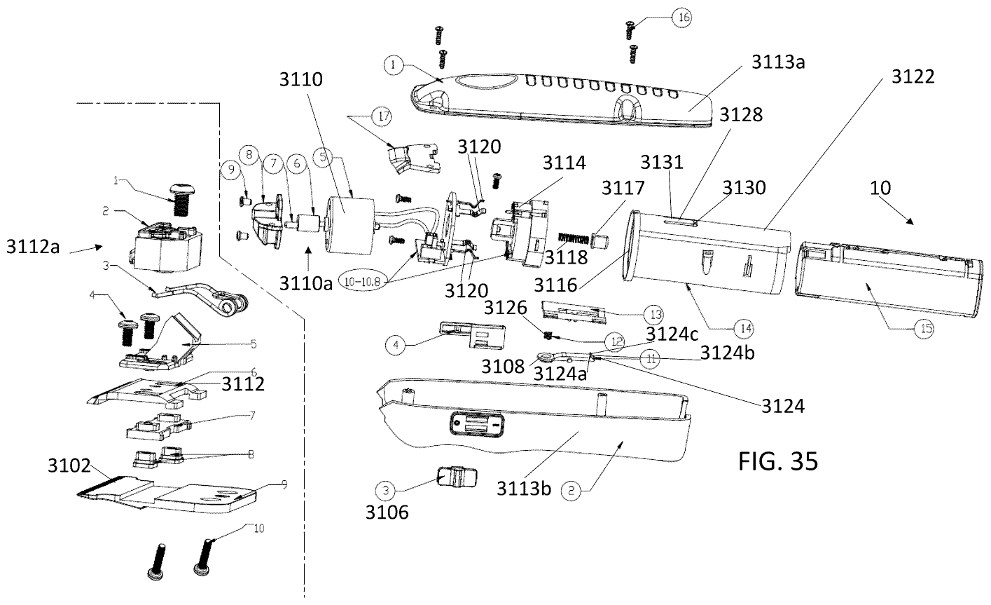

Referring to FIG. 35, third hair clipper 3100 has a motor 3110 that receives power from battery 10 when in the operational position to move a moving blade 3112 allowing a user to cut hair with third hair clipper 3100. Motor 3110 is part of a motor assembly 3110a. Moving blade 3112 is a part of a moving blade assembly 3112a. Body 3104 has a housing 3113 having a first side housing 3113a and a second side housing 3113b that houses motor 3110. Body 3104 has a casing 3114 and surrounds a cavity 3116. Casing 3114 is connected to a retractable member 3117 that extends into cavity 3116. Retractable member 3117 is biased to a release position the same as retractable member 917 of first hair clipper 900 by a first biasing member 3118. Retractable member 3117 is retractable so that a portion of retractable member 3117 is movable outside of cavity 3116 the same as retractable member 917 of first hair clipper 900, as shown in FIG. 12, when a force is applied to retractable member 3117 that overcomes a force applied to retractable member 3117 by first biasing member 3118. When the force is removed from retractable member 3117, then retractable member 3117 is urged by first biasing member 3118 back to the release position. First biasing member 3118 is shown as a spring, however, different biasing members could be used. Contacts 3120 extend into cavity 3116. Contacts 3120 can be spring members that are resilient and biased to a contact position so that each of contacts 3120 contact one of contacts 20 of battery 10 when battery 10 is in the operation position.

Still referring to FIG. 35, an inner sleeve 3122 is positioned in housing 3113. Inner sleeve 3122 forms opening 3101 through a bottom of third hair clipper 3100. Release button 3108 is connected to a fastener member 3124 that extends into cavity 3116 through inner sleeve 3122 similar to fastener member 924 extending through inner sleeve 922 of first hair clipper 900, shown in FIG. 11. Release button 3108 is biased to an outward position by a release biasing member 3126 similar to release button 908 and release biasing member 926 of first hair clipper 900, shown in FIG. 11. Release biasing member 3126 is shown as a spring, however, different biasing members could be used. When release button 3108 is biased to an outward position, fastener member 3124 is urged inward toward a center of cavity 3116. When a force is applied to release button 3108 overcoming a force applied to release button 3108 by release biasing member 3126, release button 3108 is moved inward toward a center of cavity 3116 that also moves fastener member 3124 outward away from the center of cavity 3116 similar to release button 908 and of release biasing member 926 of first hair clipper 900, shown in FIG. 11. When the force is no longer applied to release button 3108, release biasing member 3126 urges release button 3108 outward away from the center of cavity 3116 to the outward position to move fastener member 3124 inward toward the center of cavity 3116. Fastener member 3124 is shaped to have flat side 3124a, an incline ramp 3124b, and a protuberance 3124c formed between flat side 3124a and incline ramp 3124b.

Still referring to FIG. 35, a resilient member 3128 extends into cavity 3116 through inner sleeve 3122. Resilient member 3128 can be connected to inner sleeve 3122. Resilient member 3128 forms a protrusion 3130 and leg 3131 similar to protrusion 1930 and leg 1931 of second hair clipper 1900 shown in FIG. 21. Protrusion 3130 is biased to an initial position, as shown in FIG. 35. Protrusion 3130 is movable from the initial position away from the center of cavity 3116 when a force that overcomes the bias of resilient member 3128 is applied and protrusion 3130 returns to the initial position when the force is no longer applied to protrusion 3130.

Battery 10 is insertable through opening 3101 in third hair clipper 3100. Opening 3101 in third hair clipper 3100 has the same shape as the perimeter of battery 10 so that battery 10 must be inserted with the predetermined orientation aligning first groove 34 in raised portion 32 of battery 10 with resilient member 3128 in cavity 3116 of third hair clipper 3100. As battery 10 is inserted through opening 3101 in third hair clipper 3100, body 12 of battery 10 slides on inner sleeve 3122 of third hair clipper 3100 in a direction toward a side of third hair clipper 3100 having blade 3102 thereon. Battery 10 then continues to slide on inner sleeve 3122 in the direction toward a side of third hair clipper 3100 having blade 3102 so that battery 10 slides up to fastener member 3124. When a force is applied by battery 10 to fastener member 3124 overcoming the force applied to release button 3108 and fastener member 3124 by release biasing member 3126, release button 3108 is moved inward toward the center of cavity 3116 that also moves fastener member 3124 outward away from the center of cavity 3116 allowing battery 10 to continue to slide in the direction toward a side of third hair clipper 3100 having blade 3102 so that fastener member 3124 moves over first indentation 14, since fastener member 3124 is larger than first indentation 14, and protrusion 3130 of third hair clipper 3100 moves in first groove 34 of battery 10 up to first projections 42 extending from body 12 of battery 10. When a force that overcomes the bias of resilient member 3128 is applied by first projections 42 as battery 10 slides on inner sleeve 3122 in the direction toward a side of third hair clipper 3100 having blade 3102, protrusion 3130 moves from the initial position away from the center of cavity 3116 sliding over first projections 42 and protrusion 3130 returns to the initial position when the force is no longer applied to protrusion 3130 by first projections 42. Battery 10 then continues to slide on inner sleeve 3122 in the direction toward a side of third hair clipper 3100 having blade 3102 so that protrusion 3130 moves in first groove 34 of battery 10 up to second projections 46 extending from body 12 of battery 10. When a force that overcomes the bias of resilient member 3128 is applied by second projections 46 as battery 10 slides on inner sleeve 3122 in the direction toward a side of third hair clipper 3100 having blade 3102, protrusion 3130 moves from the initial position away from the center of cavity 3116 sliding over second projections 46 and protrusion 3130 returns to the initial position when the force is no longer applied to protrusion 3130 by second projections 46.

Battery 10 then continues to slide on inner sleeve 3122 in the direction toward a side of third hair clipper 3100 having blade 3102 so that protrusion 3130 of third hair clipper 3100 moves in first groove 34 of battery 10 up to retractable member 3117. When a force is applied by battery 10 to retractable member 3117 that overcomes the force applied to retractable member 3117 by first biasing member 3118, then retractable member 3117 retracts with the movement of battery 10 until fastener member 3124 is positioned over second indentation 16 in battery 10. When fastener member 3124 is positioned over second indentation 16 in battery 10 release biasing member 3126 urges fastener member 3124 into second indentation 16 in battery 10 maintaining battery 10 in the operational position. In the operational position, contacts 20 of battery 10 are each aligned with one of contacts 3120 so that electricity is conducted from battery 10 to contacts 3120 to power motor 3110 as known in the art. Retractable member 3117 is retracted from the release position in the operational position. While battery 10 is in the operational position and when the battery 10 is charged, then the user can move activation button 3106 between the activation and deactivation position to activate and deactivate third hair clipper 3100, respectively, for use of third hair clipper 3100.

Advantageously, different hair clippers can insert a fastening member into first indentation 14, second indentation 16, third indentation 18, fourth indentation 21, fifth indentation 22, sixth indentation 30, seventh indentation 56, eighth indentation 58 and/or ninth indentation 60, to allow for connection between different hair clippers and battery 10 so that battery 10 can be used with different hair clippers. For example, fastener member 924 of first hair clipper 900 is insertable into first indentation 14 of battery 10. In contrast, third hair clipper 3100 has fastener member 3124, as shown in FIG. 35, that is insertable into second indentation 16 of battery 10 so that battery 10 can be used with both first hair clipper 900 and third hair clipper 3100. Other hair clippers can have designs that have fastener members that are insertable into first indentation 14, second indentation 16, third indentation 18, fourth indentation 21, fifth indentation 22, sixth indentation 30, seventh indentation 56, eighth indentation 58 and/or ninth indentation 60 so that battery 10 can be used with several different hair clippers.

To remove battery 10 from third hair clipper 3100, a user applies force to release button 3108 overcoming the force applied to release button 3108 by release biasing member 3126, release button 3108 is moved inward toward the center of cavity 3116 that also moves fastener member 3124 outward away from the center of cavity 3116 removing fastener member 3124 from second indentation 16 allowing first biasing member 3118 to urge retractable member 3117 to move toward the release position pushing a portion of battery 10 out of opening 3101 of third hair clipper 3100 until protrusion 3130 abuts second projections 46 to maintain battery 10 in a partially removed position that prevents battery 10 from dropping out of third hair clipper 3100. The user can then grasp battery 10 and pull battery 10 in a direction away from a side of third hair clipper 3100 having blade 3102 so that a force that overcomes the bias of resilient member 3128 is applied by second projections 46 as battery 10 slides on inner sleeve 3122 in the direction away from a side of third hair clipper 3100 having blade 3102 and protrusion 3130 moves from the initial position away from the center of cavity 3116 sliding over second projections 46 and protrusion 3130 returns to the initial position when the force is no longer applied to protrusion 3130 by second projections 46. The user can continue to grasp battery 10 and pull battery 10 in the direction away from a side of third hair clipper 3100 having blade 3102 so that a force that overcomes the bias of resilient member 3128 is applied by first projections 42 as battery 10 slides on inner sleeve 3122 in the direction away from a side of third hair clipper 3100 having blade 3102 and protrusion 3130 moves from the initial position away from the center of cavity 3116 sliding over first projections 42 and protrusion 3130 returns to the initial position when the force is no longer applied to protrusion 3130 by first projections 42. The user can continue to grasp battery 10 and pull battery 10 in the direction away from a side of third hair clipper 3100 having blade 3102 to remove battery from third hair clipper 3100.

Advantageously, similar to first hair clipper 100, when release button 3108 is pressed by the user to remove battery 10 from third hair clipper 3100, battery 10 does not undesirably fall out of third hair clipper 3100 and instead only a portion of battery 10 is moved out of cavity 3116 allowing the user to remove battery in a more controlled manner by pulling battery 10 the rest of the way out of third hair clipper 3100 to avoid undesirably dropping battery 10.

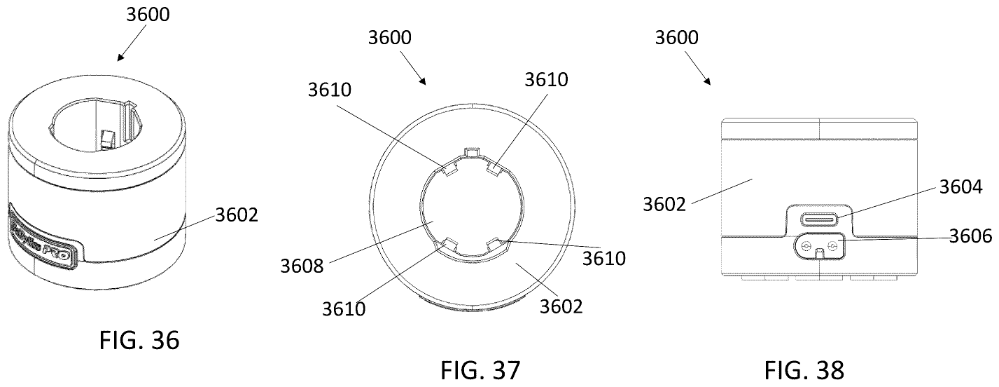

Referring to FIGS. 36-38, battery 10 is removably connectable to a battery charger 3600. Battery charger 3600 has a charger housing 3602. Battery charger 3600 has plug connectors 3604, 3606. Plug connectors 3604, 3606 connect to cords that connect battery charger 3600 to a power source, for example, an electrical outlet or USB port on a power source. Battery charger 3600 has a receptacle opening 3608 that is shaped to receive battery 10. Contacts 3610 are in receptacle opening 3608 and are positioned so that each of contacts 3610 contacts one of contacts 24a-d when battery 10 is positioned in receptacle opening 3608. During use, a cord is plugged into one of plug connectors 3604, 3606 on a first end and plug is plugged in to a power source on an opposite end, and battery 10 is positioned in receptacle opening 3608 so that each of contacts 3610 of battery charger 3600 contacts one of contacts 24a-d to charge battery 10.

Advantageously, battery 10 is a rechargeable battery that can be used in multiple hair clippers that have different designs, for example, first hair clipper 900, second hair clipper 1900 and third hair clipper 3100. Another advantage is that battery 10 can be maintained connected to the hair clipper, for example, first hair clipper 900, second hair clipper 1900 and third hair clipper 3100, when battery 10 is released from the hair clipper so battery 10 does not undesirably fall out.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes can be made and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure should not be limited to the particular embodiment(s) disclosed as the best mode contemplated, but that the disclosure will include all embodiments falling within the scope of the appended claims.

What is claimed is:

1. A rechargeable battery for a hair clipper comprising:
a body, the body having a plurality of indentations, each of the plurality of indentations being shaped to receive a fastener member of a different hair clipper.

2. The rechargeable battery of claim 1, wherein the body has substantially a cylindrical shape.

3. The rechargeable battery of claim 2, wherein the body has a first end opposite a second end, and further comprising a plurality of contacts connected to the body at the first end.

4. The rechargeable battery of claim 3, wherein the body has flattened surfaces along the cylindrical shape extending from plurality of contacts.

5. The rechargeable battery of claim 2, wherein the body has a first end opposite a second end, and further comprising a button connected to the body at a second end.

6. The rechargeable battery of claim 2, wherein the body has a plurality of lights on the second end that indicate a status of a charge of the rechargeable battery.

7. The rechargeable battery of claim 6, wherein the plurality of lights surround the button.

8. The rechargeable battery of claim 2, wherein the body has a first end opposite a second end, and wherein the plurality of indentations are at different locations along a height that extends from the first end to the second end.

9. The rechargeable battery of claim 10, wherein the plurality of indentations are different shapes and sizes.

10. The rechargeable battery of claim 2, wherein the rechargeable battery has a raised portion that extends outward from the body.

11. A rechargeable battery assembly for a hair clipper comprising:
a rechargeable battery having a body, the body having groove and a first projection in the groove; and
a cavity of the hair clipper that has a resilient member that extends into the cavity, the resilient member being insertable into the groove.

12. The rechargeable battery assembly of claim 11, wherein the body has substantially a cylindrical shape.

13. The rechargeable battery assembly of claim 11, wherein the rechargeable battery has a raised portion that extends outward from the body, wherein the body has a first end opposite a second end with a longitudinal axis therebetween, and wherein the groove is in the raised portion extending in a direction along the longitudinal axis.

14. The rechargeable battery assembly of claim 11, wherein the groove has a first portion having a first width and a second portion having a second width that is greater in size than the first width.

15. The rechargeable battery assembly of claim 14, wherein the body has a second projection formed in the second portion adjacent first projection that is closer to the first portion than the first projection.

16. The rechargeable battery assembly of claim 11, wherein the resilient member has a protrusion and at least one leg.

17. The rechargeable battery assembly of claim 16, wherein the protrusion is biased to an initial position and is movable from the initial position away from a center of the cavity when a force that overcomes a bias of the resilient member is applied.

18. The rechargeable battery assembly of claim 16, wherein the first projection applies the force that overcomes a bias of the resilient member during insertion or removal of the rechargeable battery.

19. The rechargeable battery assembly of claim 16, further comprising a retractable member that extends into the cavity that is biased to a release position.

20. The rechargeable battery assembly of claim 19, wherein the retractable member applies a force to the rechargeable battery during removal of the rechargeable battery, and wherein the resilient member contacts the projection maintaining a portion of the rechargeable battery in the cavity.
